(19) United States
(12) Patent Application Publication
(10) Pub. No.: US 2017/0046015 A1
(43) Pub. Date: Feb. 16, 2017

(54) METHOD AND APPARATUS FOR PRESENTING MULTIMEDIA INFORMATION

(71) Applicant: Xiaomi Inc., Beijing (CN)

(72) Inventors: Hongjie LIU, Beijing (CN); Wei LIU, Beijing (CN); Minghao LI, Beijing (CN)

(73) Assignee: Xiaomi Inc.

(21) Appl. No.: 15/223,839

(22) Filed: Jul. 29, 2016

(30) Foreign Application Priority Data
Aug. 13, 2015 (CN) 201510496713.6

(51) Int. Cl. G06F 3/0481; G06Q 30/02; G06F 9/44

(52) U.S. Cl. CPC G06F 3/0481; G06F 9/4443; G06Q 30/0241

(57) ABSTRACT

A method for presenting multimedia information is disclosed. The method includes: upon detecting a start event of an application, determining multimedia information to be presented in the application in accordance with predetermined presenting policies and a set of multimedia information, wherein the set of multimedia information includes at least one piece of multimedia information; and presenting the determined multimedia information in a start interface of the application.

### CROSS-REFERENCE TO RELATED APPLICATIONS

This application is based on and claims priority to Chinese Patent Application No. 201510496713.6 filed on Aug. 13, 2015, the entire contents of which are incorporated herein by reference.

### TECHNICAL FIELD

The present disclosure generally relates to a field of computer technology, and more particularly, to a method and apparatus for presenting multimedia information.

### BACKGROUND

With development of smart terminals, terminal applications become more and more popular. Presenting an opening-screen advertisement in an application gradually becomes a common way for advertisements. The opening-screen advertisement is an advertisement presented on a start interface when the application is started.

Generally, an application server associated with the application acquires a plurality of opening-screen advertisements provided by advertisers and sets presenting policies for the opening-screen advertisements in advance. The application server can determine an opening-screen advertisement to be presented in the application in accordance with the presenting policies, and the application on a terminal can employ an interface with the application server to download the opening-screen advertisement. When the application is started, the opening-screen advertisement can be presented.

A plurality of applications installed on the terminal can all present corresponding opening-screen advertisements by the above-mentioned way without interfering with each other.

### SUMMARY

According to a first aspect of the present disclosure, there is provided a method for presenting multimedia information. The method includes: upon detecting a start event of an application, determining multimedia information to be presented in the application in accordance with predetermined presenting policies and a set of multimedia information, wherein the set of multimedia information includes at least one piece of multimedia information; and presenting the determined multimedia information in a start interface of the application.

According to another aspect of the present disclosure, there is provided an apparatus for presenting multimedia information. The apparatus includes a processor and a memory configured to store instructions executable by the processor. The processor is configured to: upon detecting a start event of an application, determine multimedia information to be presented in the application in accordance with predetermined presenting policies and a set of multimedia information, wherein the set of multimedia information includes at least one piece of multimedia information; and present the multimedia information in a start interface of the application.

According to another aspect of the present disclosure, there is provided a non-transitory computer-readable storage medium storing instructions that, when executed by a processor of an apparatus, cause the apparatus to perform a method for presenting multimedia information. The method includes: upon detecting a start event of an application, determining multimedia information to be presented in the application in accordance with predetermined presenting policies and a set of multimedia information, wherein the set of multimedia information includes at least one piece of multimedia information; and presenting the multimedia information in a start interface of the application.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for presenting multimedia information, according to an exemplary embodiment.

FIG. 2 is a flow chart showing another method for presenting multimedia information, according to an exemplary embodiment.

FIG. 3 is a block diagram showing a network system, according to an exemplary embodiment.

FIG. 4 is a flow chart showing another method for presenting multimedia information, according to an exemplary embodiment.

FIG. 5 is a block diagram showing an apparatus for presenting multimedia information, according to an exemplary embodiment.

FIG. 6 is a block diagram showing an apparatus for presenting multimedia information, according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The embodiments of the present disclosure provide methods and apparatuses for presenting multimedia information.

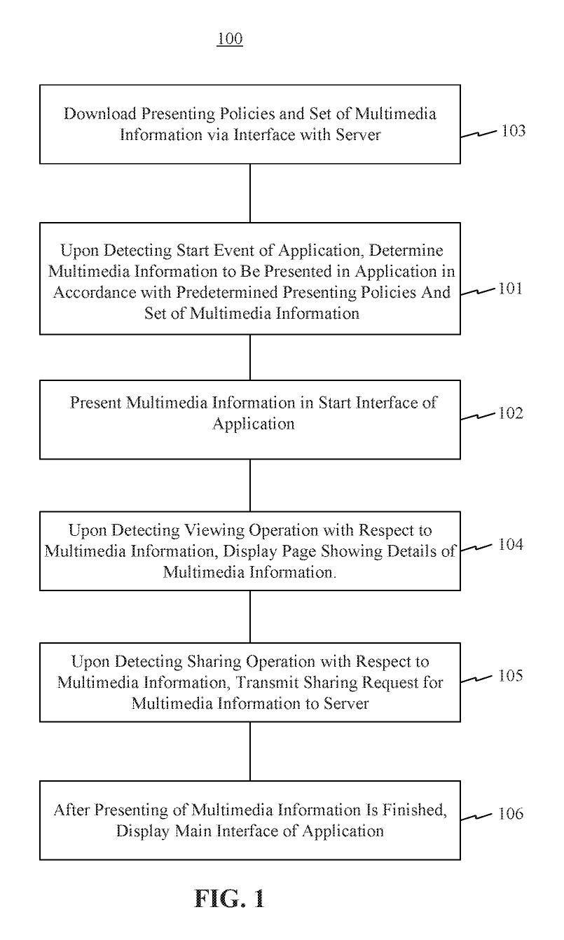

FIG. 1 is a flow chart showing a method 100 for presenting multimedia information according to an exemplary embodiment of the present disclosure. The method 100 for presenting multimedia information is performed by, for example, a terminal. As shown in FIG. 1, the method 100 includes the following steps.

In step 101, upon detecting a start event of an application, the terminal determines multimedia information to be presented in the application in accordance with predetermined presenting policies and a set of multimedia information. The set of multimedia information comprises at least one piece of multimedia information.

The terminal can have at least one application installed therein and monitor each installed application. Once an application is started, the terminal can detect a start event of the application.

In step 102, the terminal presents the multimedia information in a start interface of the application.

In related prior arts, applications on a terminal may be associated with different application servers, respectively. With respect to each application, an application server associated with the application is required to set the presenting policies for the multimedia information and determine multimedia information to be presented in the application in accordance with the presenting policies. The terminal is required to download the multimedia information for presentation from the application server via the application. However, downloading the multimedia information consumes network resources and electric power of the terminal. Each application on the terminal needs to download multimedia information in the above described way. Even if two different applications on the terminal acquire the same multimedia information, the terminal is required to download the multimedia information from different application servers via the two different applications respectively. The same multimedia information is repeatedly downloaded and thus the network resources and the electric power of the terminal are wasted.

Consistent with embodiments of the present disclosure, the terminal implements unified management policies on each application installed thereon. The terminal sets or acquires the presenting policies and the set of multimedia information in advance, and monitors each application when it is in operation. Upon detecting a start event of an application, the terminal presents the multimedia information in the application. The terminal downloads the presenting policies and the set of multimedia information once and can apply them to all applications installed thereon. It is unnecessary for each application to separately download the multimedia information from a corresponding application server, which avoids the same multimedia information being repeatedly downloaded and thus saves the network resources and the electric power of the terminal.

In the illustrated embodiment, by employing unified management policies across installed applications, upon detecting the start event of an application, the multimedia information to be presented in the application is determined in accordance with the predetermined presenting policies and the set of multimedia information. The multimedia information is presented in the start interface of the application without downloading the multimedia information from the application servers on an application-by-application basis, which avoids the same multimedia information being repeatedly downloaded and saves the network resources and the electric power of the terminal.

In one exemplary embodiment, the method 100 further comprises step 103, e.g., before step 101. In step 103, the terminal downloads the presenting policies and the set of multimedia information via an interface with a server.

In some embodiments, the step 101 of determining multimedia information to be presented in the application in accordance with the predetermined presenting policies and the set of multimedia information may include: when the presenting policies comprise a list of presenting applications, determining whether the application that is started is included in the list of presenting applications; when the started application is included in the list of presenting applications, determining the multimedia information to be presented in the application in accordance with the presenting policies and the set of multimedia information.

In some embodiments, the step 101 of determining multimedia information to be presented in the application in accordance with the predetermined presenting policies and the set of multimedia information comprises: when the presenting policies comprise a presenting time period of the application, acquiring a system time indicated by a system clock; determining whether the system time is within the presenting time period; and when the system time is within the presenting time period, determining the multimedia information to be presented in the application in accordance with the presenting policies and the set of multimedia information.

In some embodiments, the step 101 of determining multimedia information to be presented in the application in accordance with the predetermined presenting policies and a set of multimedia information comprises: when the presenting policies comprise a first presenting frequency, calculating a total presenting frequency on the basis of presenting frequencies of applications on the terminal, wherein the first presenting frequency is a maximum presenting frequency of the terminal; and when the total presenting frequency is less than the first presenting frequency, determining the multimedia information to be presented in the application in accordance with the presenting policies and the set of multimedia information.

In some embodiments, the step 101 of determining multimedia information to be presented in the application in accordance with the predetermined presenting policies and the set of multimedia information comprises: when the presenting policies comprise designated multimedia information corresponding to the started application, acquiring the designated multimedia information corresponding to the started application from the set of multimedia information.

In some embodiments, the presenting policies comprise a plurality of pieces of designated multimedia information corresponding to the application and second presenting frequencies corresponding to the pieces of designated multimedia information. Each of the second presenting frequencies is the maximum presenting frequency a corresponding piece of designated multimedia information can be presented. The step 101 comprises: for each piece of designated multimedia information corresponding to the application, acquiring the presenting frequency of the designated multimedia information. When the presenting frequency of the designated multimedia information is less than a second presenting frequency corresponding to the designated multimedia information, the step 101 further comprises: determining the designated multimedia information to be the multimedia information to be presented in the application.

In some embodiments, the step 101 of determining multimedia information to be presented in the application in accordance with the predetermined presenting policies and the set of multimedia information comprises: acquiring a current weight of each piece of multimedia information in the set of multimedia information. The weight is used to indicate a probability of a corresponding piece of multimedia information being selected for presentation. The step 101 further comprises: selecting a piece of multimedia information to be presented in the application from the set of multimedia information based on the current weights of the pieces of the multimedia information. In one embodiment, the pieces of the multimedia information are selected in the order of from having a largest current weight to having a smallest current weight.

In some embodiments, the method 100 further comprises steps 104-106. In step 104, upon detecting a viewing operation with respect to the multimedia information, the terminal displays a page showing the details of the multimedia information. In step 105, upon detecting a sharing operation with respect to the multimedia information, the terminal transmits a sharing request for the multimedia information to the server. In step 106, after the presenting of the multimedia information is finished, the terminal displays a main interface of the application.

The present disclosure also contemplates that all or portions of the above embodiments can be randomly combined, and that one or more of the above described steps may be omitted in some embodiments.

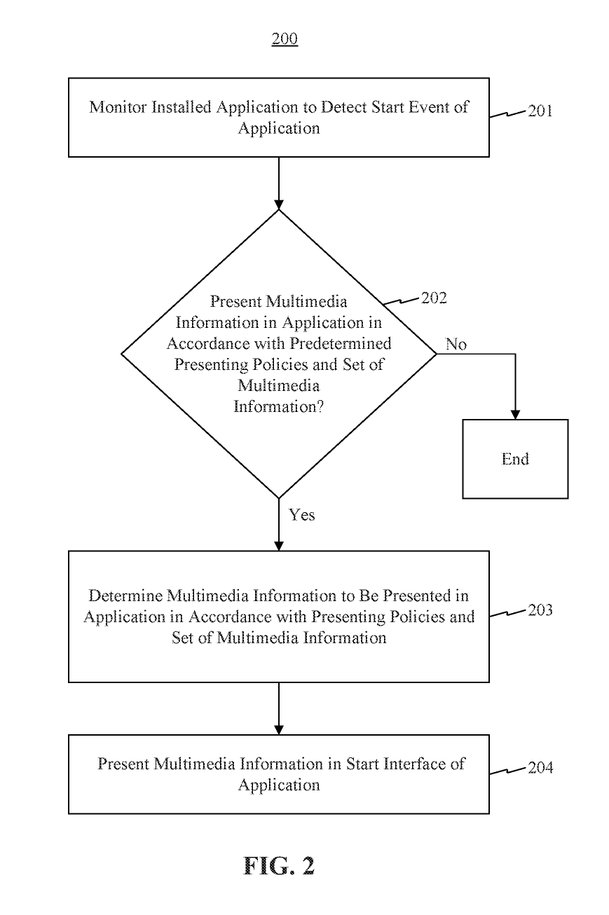

FIG. 2 is a flow chart showing a method 200 for presenting multimedia information according to an exemplary embodiment of the present disclosure. The method 200 may be performed by a terminal. As shown in FIG. 2, the method 200 comprises the following steps.

In step 201, the terminal monitors each installed application to detect a start event of an application.

The terminal may be a mobile phone, a computer, a tablet computer, and so on, and can have at least one application installed thereon. The application may be, for example, a chat application, a shopping application, a video playing application, and so on.

In one embodiment, the terminal can monitor each application installed thereon. The terminal can detect a start event of an application, and present multimedia information in the started application. For example, the terminal displays the multimedia information as an opening-screen advertisement of the application.

The start event can be triggered by a user operation of starting the application, which can be a click/touch operation on an icon of the application, or a selecting operation on the application in a start menu.

In step 202, the terminal determines whether to present multimedia information in the application in accordance with predetermined presenting policies and a set of multimedia information. If so, then the method 200 continues to step 203, otherwise, the method 200 ends.

The presenting policies are used to manage the presenting of the multimedia information in an application. For example, the presenting policies govern a presenting time of the multimedia information and manage the application in which the multimedia information is to be presented and so on, which are not limited in the illustrated embodiment. The set of multimedia information comprises at least one piece of multimedia information. In some embodiments, each piece of multimedia information can comprise at least one of picture information, video information, audio information, or a webpage link address. In some embodiments, the multimedia information can comprise information about cosmetics, clothes, commodities, and so on, which is not limited in the illustrated embodiment.

The presenting policies and the set of multimedia information can be determined by a server associated with the terminal by means of negotiating with an advertiser device, which generates the multimedia information. The server can further update the presenting policies and the set of multimedia information during operation. The terminal can download and save the presenting policies and the set of multimedia information from the server.

For example, the terminal downloads the presenting policies and the set of multimedia information via an interface with the server. The terminal can employ the interface with the server and download the presenting policies and the set of multimedia information in real time or periodically. The download cycle can be 10 hours, 24 hours, and so on, which is not limited in the embodiment.

In one embodiment, the server may update the presenting policies and the set of multimedia information. The terminal can also download the updated presenting policies and the set of multimedia information from the server after they are updated. For example, the server can generate a new presenting data file and version information of the presenting data file on the basis of the updated presenting policies and the set of the multimedia information. The version information can comprise a version name, the time it is generated, and so on of the presenting data file. The terminal can acquire the version information, and determine whether the version information is the same as that of the presenting data file currently stored in the terminal. If the terminal determines that the version information is different from the currently stored, which indicates that the server has already updated the presenting data file, then the terminal calls up the interface with the server, downloads and interprets/decodes the updated presenting data file, and acquires the updated presenting policies and the set of multimedia information.

In some embodiments, the terminal not only can collectively download the presenting policies and the set of multimedia information at the same time, but also separately download the presenting policies and the set of multimedia information. For example, the server can generate a presenting policy file on the basis of the predetermined presenting policies, and generate a presenting information file on the basis of the predetermined set of multimedia information. When the server updates the presenting policy file, the terminal can download the updated presenting policy file from the server, interpret/decode the updated presenting policy file, and acquire the updated presenting policies. Meanwhile, the terminal can manage the set of multimedia information that is currently stored in the terminal in accordance with the updated presenting policies. In some embodiments, when the server updates the presenting information file, the terminal can download the updated presenting information file from the server, interpret/decode the presenting information file, and acquire a set of updated multimedia information. The terminal can manage the set of updated multimedia information in accordance with the presenting policies that are currently stored in the terminal.

In the illustrated embodiment, upon detecting the start event of the application, the terminal can determine whether to present the multimedia information in the application in accordance with the presenting policies and the set of multimedia information that are currently saved in the terminal. In some embodiments, step 202 may be implemented by at least one of the following methods:

In a first method, when the presenting policies comprise a list of presenting applications, it is determined whether the application that is started is included in the list of presenting applications. If so, the method 200 continues to step 203. If not, the method 200 ends.

The presenting polices can comprise the list of presenting applications, which comprises at least one application in which the multimedia information is allowed to be presented. The terminal can determine whether the started application is included in the list of presenting applications. When the started application is included in the list of presenting applications, which indicates that it is allowed to present the multimedia information in the application, the terminal continues to step 203. When the list of presenting applications does not comprise the application that is started, which indicates that it is not allowed to present the multimedia information in the application, the terminal does not present the multimedia information in the application.

In a second method, when the presenting policies comprise a presenting time period of the application, a system time, for example, currently shown on a system clock is acquired. It is determined whether the system time is within the presenting time period. If so, the method 200 continues to step 203. If not, the method 200 ends.

The presenting policies can further comprise a presenting time period for each of the installed applications. The presenting time period is used to specify a time period in which it is allowed to present the multimedia information in a corresponding application. The presenting time periods of different applications can be the same or different, which are not limited in the embodiment.

The terminal can acquire the presenting time period of the application and the system time currently shown on the clock, and determine whether the system time is within the presenting time period. When the system time is within the presenting time period, which indicates that it is allowed to present the multimedia information in the application, the terminal continues to step 203. When the system time is not within the presenting time period, which indicates that it is not allowed to present the multimedia information, the terminal does not present the multimedia information in the application.

In a third method, when the presenting policies comprise a first presenting frequency, a total presenting frequency is calculated on the basis of presenting frequencies of the applications of the terminal. For example, the total presenting frequency is a sum of all presenting frequencies of the applications. The terminal determines whether the total presenting frequency is less than the first presenting frequency. If so, the method 200 continues to step 203. If not, the method 200 ends.

In one embodiment, the terminal presents the multimedia information in a plurality of applications. If the presenting frequency is too high, the user may feel disgusted and user experience may be negatively affected. Therefore, the presenting policies can comprise the first presenting frequency, which is used to limit the presenting frequency of the terminal presenting the multimedia information.

In the process of presenting the multimedia information, the terminal can generate a presenting record, which comprises the multimedia information that has been presented by the applications. When determining whether to present the multimedia information in a currently-started application, the terminal can acquire the presenting frequencies of the multimedia information in the applications and calculate the total presenting frequency of the terminal on the basis of the presenting frequencies of the applications on the terminal. The terminal determines whether the total presenting frequency of the terminal is less than the first presenting frequency. When the total presenting frequency is less than the first presenting frequency, the terminal can further present the multimedia information in the currently-started application and execute the step 203. The frequency of the terminal presenting the multimedia information may be too high when the total presenting frequency is not less than the first presenting frequency. The terminal stops presenting the multimedia information in the currently-started application.

The presenting frequency of the application can be calculated by counting presenting times within a predetermined time period. The predetermined time period can be one day, one week, and so on in accordance with the presenting policies, which is not limited in the embodiment. For example, if the predetermined time period is one day and an application has already presented the multimedia information three times in one day, then the presenting frequency of the application is three.

It should be appreciated that the first, second, and third methods described above are provided as examples, and the terminal can determine whether to present the multimedia information in the application by one or more of these methods. In one embodiment, the terminal can randomly combine two or three of these methods to determine whether to present the multimedia information in the application.

For example, the first and second methods can be combined. When the presenting policies comprise the list of presenting applications, the terminal determines whether the currently-started application is in the list of presenting applications and acquires the presenting time period of the application if the currently-started application is in the list of presenting applications. The terminal acquires the system time currently shown on the clock and determines whether the system time is within the presenting time period. If the system time is within the presenting time period, the terminal determines to present the multimedia information in the application and executes the step 203. If the currently-started application is not in the list of presenting applications or the system time is not within the presenting time period, the terminal does not present the multimedia information in the currently-started application.

Furthermore, the terminal can employ other methods to determine whether to present the multimedia information in the application. The present disclosure is limited by the methods explained above.

In some embodiments, upon determining not to present the multimedia information in the application, the terminal may execute a corresponding start operation in the application, for example, displaying a main interface of the application, loading user information in the application and so on.

In step 203, when the terminal determines to present the multimedia information in the application, the terminal selects/determines the multimedia information to be presented in the application in accordance with the presenting policies and the set of multimedia information.

Upon determining to present the multimedia information in the application, the terminal can select the multimedia information to be presented in the application from the set of multimedia information.

In some embodiments, the presenting policies can comprise designated multimedia information for a corresponding application. That is, the presenting policies can specify the multimedia information to be presented in a corresponding application in advance. In one embodiment, the terminal can present the designated multimedia information when the corresponding application is started, and cannot present any other multimedia information. The designated multimedia information corresponding to each of the applications can be determined by the advertiser providing the multimedia information, or by a maker of the terminal, or by the advertiser by means of negotiating with the maker of the terminal, which is not limited in the embodiment.

Upon determining to present the multimedia information in the application, the terminal determines whether the presenting policies comprise the designated multimedia information for a corresponding application. If so, the terminal acquires the designated multimedia information corresponding to the application from the set of multimedia information so as to present the designated multimedia information in the application. For example, the presenting policies can comprise a memory address of the designated multimedia information corresponding to the application, and acquire the designated multimedia information in accordance with the memory address.

When the presenting policies comprise a plurality of pieces of designated multimedia information corresponding to the application, the terminal can acquire the plurality of pieces of designated multimedia information so as to present the plurality of pieces of designated multimedia information in the application.

The terminal can further select one of the plurality of pieces of designated multimedia information in accordance with the presenting frequencies. A presenting frequency is used to indicate the number of times the designated multimedia information has been presented. For example, the terminal may select a piece of designated multimedia information for presentation when the designated multimedia information was presented less than other pieces of designated multimedia information.

For example, the terminal can calculate the presenting frequencies of the pieces of designated multimedia information and select a piece of designated multimedia information having a presenting frequency that is the least, from the plurality of pieces of multimedia information as the multimedia information to be presented in the application. In one embodiment, the presenting policies can further comprise second presenting frequencies corresponding to the pieces of designated multimedia information. A second presenting frequency is the maximum presenting frequency a corresponding piece of designated multimedia information can be presented. For each piece of designated multimedia information corresponding to the application, the terminal can acquire the presenting frequency of the designated multimedia information and determine whether the presenting frequency is less than a second presenting frequency corresponding to the designated multimedia information. If the presenting frequency is less than the second presenting frequency, the designated multimedia information can be presented and is selected as the multimedia information to be presented in the application. The frequency of the terminal presenting the designated multimedia information may be too high when the presenting frequency is not less than the second presenting frequency of the designated multimedia information. Under the circumstance, the designated multimedia information is not presented.

In some embodiments, the presenting frequency of the designated multimedia information can be a quotient of the times of the designated multimedia information presented by the terminal and the total times of all pieces of the multimedia information presented by the terminal.

In some embodiments, a plurality of pieces of designated multimedia information are selected to be presented in an application. The presenting frequency of a first piece of designated multimedia information can be a quotient of the times of the first piece of designated multimedia information presented in the application and the total times of the plurality of pieces of designated multimedia information presented in the application.

In some embodiments, the terminal does not designate multimedia information for presentation in an application in advance. The terminal can assign a weight to each piece of multimedia information in the set of multimedia information, and selects a piece of multimedia information to be presented in the application from the set of multimedia information according to the weights of the pieces of multimedia information. For example, the terminal may select the multimedia information having the largest weight to be presented in the currently-started application.

In some embodiments, the terminal can line up the pieces of multimedia information according to their weights, and select a piece of multimedia information having the largest weight. The terminal can also select a predetermined number of pieces of multimedia information from the set of multimedia information each having a weight greater than a predetermined weight, to be presented in an application. The predetermined number can be determined in accordance with the presenting policies, and can be the same or different for different applications of the terminal, which is not limited in the embodiment.

In one embodiment, a weight is used to indicate the probability of a piece of multimedia information being selected for presentation. Each of the weights of the pieces of multimedia information can be in a predetermined range, for example, from 0 to 1 or from 0 to 10. A sum of the weights of the plurality of pieces of multimedia information can be 1 or another value, which is not limited in the embodiment. The weights of the pieces of multimedia information can be determined by the terminal in accordance with the presenting policies, and updated by the terminal whenever appreciate.

For example, upon presenting a piece of multimedia information in an application, the terminal can decrease the weight of the multimedia information, such that when another application is started later, the terminal will not present the multimedia information whose weight is decreased and will present another multimedia information having a larger weight. By means of decreasing the weight of the multimedia information that has been presented and increasing the weight of the multimedia information that has not been presented, respective pieces of multimedia information can be evenly presented so as to avoid a piece of multimedia information being presented more frequently than others.

In one embodiment, upon detecting a start event of an application, the terminal acquires the type of the application. When the terminal determines that the type of a piece of multimedia information in the set of multimedia information is the same as that of the application, the terminal increases the weight of the multimedia information so as to increase the probability of the multimedia information being selected. For example, when the currently-started application is a video-playing application, the terminal can increase the weight of a piece of movie multimedia information in the set of multimedia information.

In one embodiment, when the terminal determines that the type of a piece of multimedia information is the same as that of the application, the terminal can also directly select and present the multimedia information in the application without regard to the weight of the piece of multimedia information. How the terminal selects the multimedia information is not limited in the present disclosure.

In step 204, the terminal presents the multimedia information in a start interface of the application.

Upon determining the multimedia information to be presented in the application, the terminal can display the start interface of the application and presents the multimedia information in the start interface. For example, when the multimedia information comprises picture information, the terminal displays the picture information in the start interface; when the multimedia information is video information, the terminal plays the video information in the start interface.

After the terminal determines a piece of multimedia information to be presented in the application, the terminal presents the multimedia information in the start interface. When the terminal has determined a plurality of pieces of multimedia information to be presented in the application, the terminal presents the plurality of pieces of multimedia information in turn or at the same time in the start interface. In one embodiment, the terminal can also assign the plurality of pieces of multimedia information into two or more groups, each of which comprise one or more pieces of multimedia information. The terminal can first present a first group of multimedia information and then present another group in the start interface. The way of presenting the plurality of pieces of multimedia information can be determined in accordance with the presenting policies, which is not limited in the embodiment.

In one embodiment, when an application is started, the terminal displays the main interface of the application in the application. In one embodiment, the terminal can display a start interface and then present the multimedia information in the start interface. After the terminal presents the multimedia information and the user does not trigger any operation corresponding to the multimedia information, the terminal displays the main interface of the application after the presenting of the multimedia information is complete.

In one embodiment, the presenting of the multimedia information is finished when a duration of presenting the multimedia information reaches a predetermined duration. The predetermined duration can be determined in accordance with the presenting policies. Predetermined durations corresponding to different pieces of multimedia information or different applications can be the same or different, which are not limited in the embodiment.

In one embodiment, the terminal can first display the start interface without displaying the main interface of the application, and then display the main interface after the presenting of the multimedia information is complete. In one embodiment, the terminal can display the main interface of the application in the application and display the start interface on top of the main interface, so as to overlap the main interface and present the multimedia information in the start interface. After the presenting of the multimedia information is complete, the terminal cancels the display of the start interface while the terminal displays the main interface.

When the terminal presents the multimedia information, the user can invoke a view operation on the multimedia information. The viewing operation can be a click or touch on the multimedia information or another operation, which is not limited in the embodiment. Upon detecting the viewing operation on the multimedia information, the terminal can display a page showing detailed information of the multimedia information. Subsequently, the terminal can display the main interface of the application upon closing the detailed information page.

The detailed information page can comprise detailed information of the multimedia information, for example, a brand, a price, a maker and so on of the product in the multimedia information. The detailed information is not limited to the above examples and can include other useful information. The detailed information page can be downloaded in advance by the terminal from the server, or from a server corresponding to the multimedia information. For example, when the multimedia information is a webpage link address, the terminal transmits an access request to a server corresponding to the webpage link address, and receives a webpage returned from the server. The webpage is the detailed information page of the multimedia information.

When the terminal presents the multimedia information, the user can also invoke a sharing operation on the multimedia information. For example, the start interface can comprise a sharing option. The user invokes the sharing operation by clicking/touch the sharing option. When the terminal detects that the sharing operation is invoked with respect to the multimedia information, the terminal transmits a sharing request for the multimedia information to the server. When the server receives the sharing request, it issues a message sharing the multimedia information, so that other terminals coupled to the terminal can view the message and learn that the terminal is sharing the multimedia information. Moreover, upon transmitting the sharing request to the server, the terminal can display the main interface of the application.

In one embodiment, upon finishing presenting the multimedia information, the terminal can update the generated presenting record by linking the application to the multimedia information in the presenting record to indicate that the multimedia information has been presented in the application. Furthermore, the terminal can also add to the presenting record the time when the application presents the multimedia information, the operation the user invokes while the multimedia information is presented and so on, which is not limited in the embodiment. Further, the terminal can transmit the presenting record to the server for to be store therein.

After downloading the presenting policies and the set of multimedia information, the terminal can still present the multimedia information in the application and generate the presenting record, even when the terminal is disconnected from the network. The method 200 can be executed by the terminal off-line without connecting to the network. Subsequently, when the terminal restores the network connection with the server, the terminal transmits the presenting record to the server.

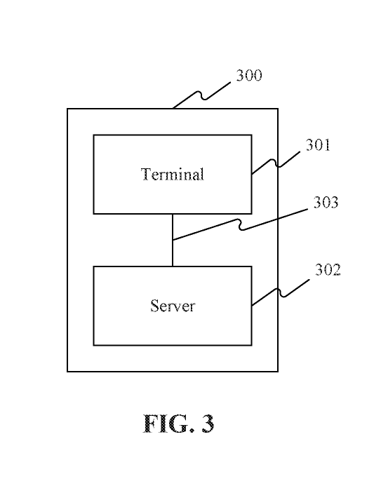

FIG. 3 is a block diagram of a network system 300 for presenting multimedia information. As shown in FIG. 3, the network system 300 comprises a terminal 301 and a server 302. The terminal 301 is coupled with the server 302 via a network 303. The server 302 is configured to provide services to the terminal 301. The server 302 can set presenting policies and acquire a set of multimedia information. The terminal 301 can employ an interface with the server 302, download the presenting policies and the set of multimedia information from the server 302, and present multimedia information in an application in accordance with the presenting policies and the set of multimedia information.

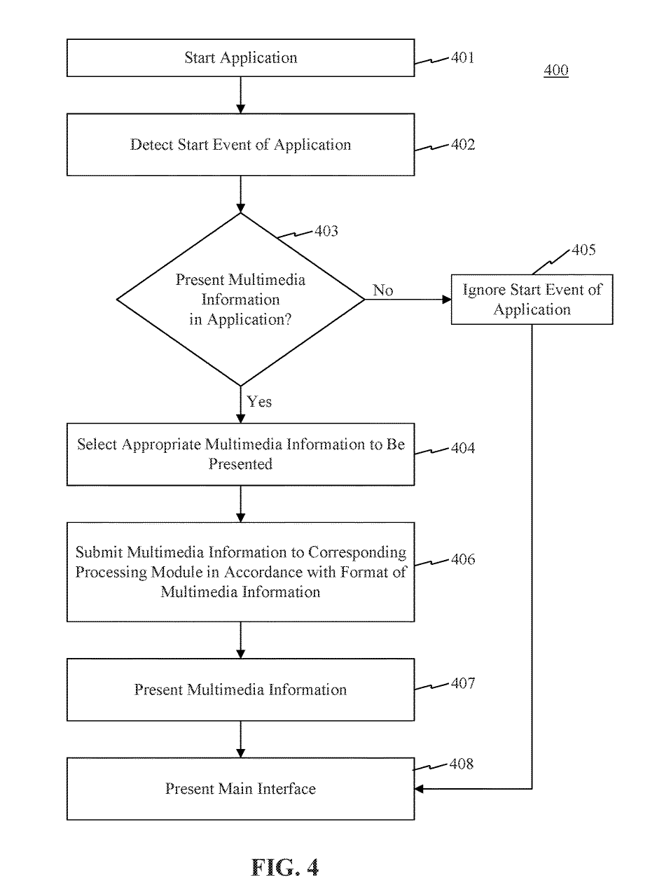

As explained above, the methods 100 and 200 can be executed by a terminal, such as the terminal 301. In some embodiments, the terminal 301 can execute a software program including instructions implementing methods consistent with embodiments of the present disclosure. FIG. 4 is a flow chart showing a method 400 for presenting multimedia information. The method 400 may be executed by the terminal 301 (FIG. 3). As shown in FIG. 4, the method 400 includes steps 401-408.

In step 401, the terminal 301 starts an application in response to a user operation. In step 402, the terminal 301 monitors start and close events of each application and, when the application is started, detects a start event of the application.

In step 403, the terminal 301 determines whether to present multimedia information in the application. If so, in step 404, the terminal 301 selects appropriate multimedia information from a plurality of pieces of predetermined multimedia information.

The terminal 301 can download the presenting policies and the multimedia information from the server 302, and determine whether to present the multimedia information in the application in accordance with the presenting policies. If the terminal 301 determines not to present the multimedia information in the application, in step 405, it ignores the start event of the application and in step 408 presents a main interface, e.g., a screen page, in the application. If the terminal 301 determines to present the multimedia information in the application, in step 404, it selects appropriate multimedia information.

In step 406, upon determining the multimedia information to be presented in the application, the terminal 301 submits the multimedia information to a corresponding processing module in accordance with a format of the multimedia information. In step 407, the multimedia information is presented by the processing module of the terminal 301.

The multimedia information can be information of different formats, such as picture information, video information, audio information and so on. The terminal 301 can determine the format of the multimedia information and submit the multimedia information to the processing module corresponding to the format, such that the multimedia information is presented by the processing module.

For example, when the multimedia information is the picture information, the terminal 301 submits the picture information to a display module for displaying; when the multimedia information is the video information, the terminal 301 submits the video information to a video player module for playing.

In step 408, after the presenting of the multimedia information is finished, the terminal 301 presents the main interface in the application.

Consistent with embodiments of the present disclosure, the terminal implements unified management policies on each application installed thereon. The terminal sets or acquires the presenting policies and the set of multimedia information in advance, and monitors each application when it is in operation. Upon detecting the start event of an application, the terminal presents the multimedia information in the application. The terminal downloads the presenting policies and the set of multimedia information once and can apply them to applications installed thereon. It is unnecessary for each application to separately download the multimedia information from a corresponding application server, which avoids the same multimedia information being repeatedly downloaded and thus saves the network resources and the electric power of the terminal.

In related prior art, a plurality of application servers set the presenting policies separately, and each application individually downloads advertisement resources from a corresponding server. In practice, it is required for the producer of the application to negotiate with an advertiser in accordance with its own requirements, and the advertiser determines whether to present an opening-screen advertisement in accordance with the quantity of users of the application. Once the advertiser decides to present the opening-screen advertisement in the application, the application server is required to integrate data packages of the opening-screen advertisements provided by the advertiser and configure several presenting policies to manage the opening-screen advertisements to be presented. The application on the terminal is required to call up a corresponding interface to acquire the opening-screen advertisement so as to present the opening-screen advertisement. It is quite complicated and tedious to configure the application server, and the application on the terminal is required to acquire the latest resources from the server. If an application on the terminal frequently communicates with a corresponding application server, a large amount of network resources and electric power of the terminal will be consumed. It is difficult to find an appropriate advertiser for some applications, the quantity of users of which is relatively few, so the presenting of the opening-screen advertisement cannot be implemented. Furthermore, respective applications on the terminal operate separately, and cannot be uniformly managed.

Referring to FIG. 3, in the illustrated embodiment, the network system 300 includes the terminal 301 and the server 302. The presenting policies and the advertisement resources (multimedia information) are downloaded by the terminal 301 from the server 302 once so as to present the opening-screen advertisements in different applications. That is to say, a plurality of applications can be managed with unified management policies. The terminal 301 can upgrade and update the presenting policies and the advertisement resources by periodically acquiring version information from the server. It is unnecessary for each application to individually download the advertisement resources from a corresponding application server, to avoid repeated downloading of the same advertisement resources and waste of the network resources and electric power. The terminal 301 thus consumes less network resources and electric power. The terminal 301 further employs presenting polices such as time period control policies, frequency control policies and so on, in order to improve the user experience of the terminal 301. Furthermore, the server 302 of the terminal 301 configures a copy of presenting policies and advertisement resources. It is unnecessary for the individual application server to configure the presenting policies and the advertisement resources, so the operation of the application server is simplified.

The present disclosure provides a system-level platform for presenting the opening-screen advertisement on the terminal. The maker of the terminal can negotiate with advertisers to automatically present an appropriate opening-screen advertisement when a specific application is started. Regardless of the quantity of users of an application, as long as the advertiser reaches an agreement with the maker of the terminal, the opening-screen advertisement can be presented to achieve advertising effects without configuring the application servers, acquiring presenting policies and interface from the application servers, and periodically acquiring any advertisement resource from the application servers.

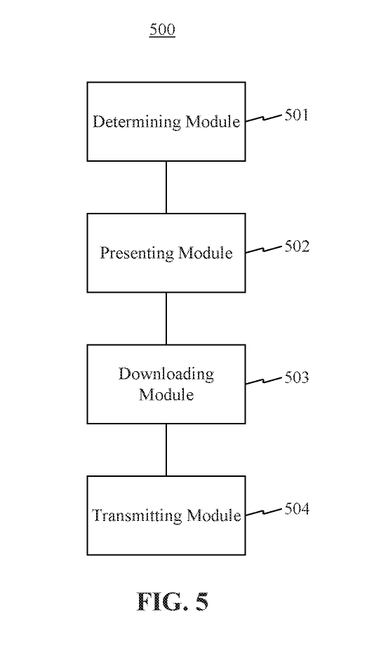

FIG. 5 is a block diagram showing an apparatus 500 for presenting multimedia information in accordance with an exemplary embodiment. The apparatus 500 may be a terminal, such as the terminal 301 (FIG. 3). Referring to FIG. 5, the apparatus 500 comprises a determining module 501 and a presenting module 502.

The determining module 501 is configured to, upon detecting a start event of an application, determine multimedia information to be presented in the application in accordance with predetermined presenting policies and a set of multimedia information. The set of multimedia information comprises at least one piece of multimedia information. The presenting module 502 is configured to present the multimedia information in a start interface of the application.

Consistent with embodiments of the present disclosure, the apparatus 500 implements unified management policies on each application installed thereon. The apparatus 500 sets or acquires the presenting policies and the set of multimedia information in advance, and monitors each application when it is in operation. Upon detecting the start event of an application, the apparatus 500 presents the multimedia information in the application. The apparatus 500 downloads the presenting policies and the set of multimedia information once and can apply them to applications installed thereon. It is unnecessary for each application to separately download the multimedia information from a corresponding application server, which avoids the same multimedia information being repeatedly downloaded and thus saves the network resources and the electric power of the terminal.

In another embodiment, the apparatus 500 further comprises a downloading module 503 configured to download the presenting policies and the set of multimedia information through an interface with a server.

In another embodiment, the determining module 501 is further configured to determine whether the application is included in a list of presenting applications when the presenting policies comprise the list of presenting applications; and determine the multimedia information to be presented in the application in accordance with the presenting policies and the set of multimedia information when the application is included in the list of presenting applications.

In another embodiment, the determining module 501 is further configured to acquire a system time currently indicated by a system clock when the presenting policies comprise a presenting time period of the application; determine whether the system time is within the presenting time period; and determine the multimedia information to be presented in the application in accordance with the presenting policies and the set of multimedia information when the system time is within the presenting time period.

In another embodiment, the determining module 501 is further configured to calculate a total presenting frequency on the basis of presenting frequencies of each of the applications installed on the apparatus 500 when the presenting policies comprise a first presenting frequency. The first presenting frequency is used to indicate a maximum presenting frequency of the terminal. The determining module 501 is further configured to determine the multimedia information to be presented in the application in accordance with the presenting policies and the set of multimedia information when the total presenting frequency is less than the first presenting frequency.

In another embodiment, the determining module 501 is further configured to acquire designated multimedia information corresponding to the application from the set of multimedia information when the presenting policies further comprise the designated multimedia information corresponding to the application.

In another embodiment, the presenting policies comprise a plurality of pieces of designated multimedia information corresponding to the application and second presenting frequencies corresponding to the pieces of designated multimedia information. Each of the second presenting frequencies is the maximum presenting frequency that a corresponding piece of designated multimedia information can be presented. The determining module 501 is further configured to, for each piece of designated multimedia information corresponding to the application, acquire the presenting frequency of the designated multimedia information; and when the presenting frequency of the designated multimedia information is less than a second presenting frequency corresponding to the designated multimedia information, determine that the designated multimedia information is the multimedia information to be presented in the application.

In another embodiment, the determining module 501 is further configured to acquire a current weight of each piece of multimedia information in the set of multimedia information. The weight is used to indicate a probability of a corresponding piece of multimedia information being selected for presentation. The determining module 501 is further configured to select a piece of multimedia information to be presented in the application from the set of multimedia information based on the current weights of the pieces of the multimedia information. In one embodiment, the pieces of the multimedia information are selected in the order of from having the largest to having the smallest current weight.

In another embodiment, the presenting module 502 is further configured to display a page showing detailed information of the multimedia information upon detecting a viewing operation with respect to the multimedia information, and display a main interface of the application after the presenting of the multimedia information is complete. In some embodiments, the apparatus 500 further comprises a transmitting module 504 configured to transmit a sharing request for the multimedia information to a server upon detecting a sharing operation with respect to the multimedia information.

Specific operations of respective modules of the apparatus 500 above have been described in detail in the method embodiments and thus are not described herein.

It should be appreciated that functions and operations executed by the modules explained above are exemplary. In some embodiments, the functions and/or operations can be implemented by different modules as actually required. That is, the internal structure of the apparatus 500 may include different functional modules or sub-modules to implement all or some of the above described functions. Furthermore, the apparatus 500 for presenting multimedia information has the same technical concept as the methods 100, 200, and 400 for presenting multimedia information. The specific implementations of the apparatus 500 can be appreciated by referring to the description of methods 100, 200, and 400, and are not repeated.

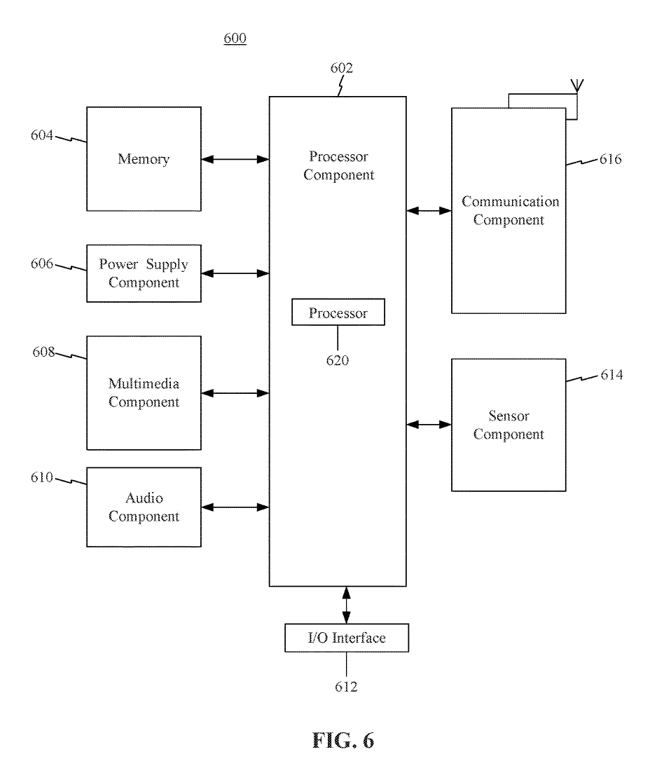

FIG. 6 is a block diagram showing an apparatus 600 for presenting multimedia information in accordance with an exemplary embodiment of the present disclosure. The apparatus 600 may one of the terminals explained above. For example, the apparatus 600 can be a mobile phone, a computer, a digital broadcast terminal, a message transceiver, a game console, a tablet device, medical equipment, a fitness facility, a personal digital assistant and so on.

As shown in FIG. 6, the apparatus 600 can comprise one or more of the following components: a processor component 602, a memory 604, a power supply component 606, a multimedia component 608, an audio component 610, an input/output (I/O) interface 612, a sensor component 614, and a communication component 616.

The processor component 602 usually controls operations of the whole apparatus 600, for example, operations related to display, telephone call, data communication, camera operation and recording operation and so on. The processor component 602 can comprise one or more processors 620 to execute instructions so as to implement all or part of the steps of the above methods. Moreover, the processor component 602 can comprise one or more modules for facilitating interactions between the processor component 602 and other components. For example, the processor component 602 can comprise a multimedia module for facilitating interactions between the multimedia component 608 and the processor component 602.

The memory 604 is configured to store various types of data for supporting operations of the apparatus 600. Examples of the data comprise instructions of any application program or method operating on the apparatus 600, contact data, directory data, messages, pictures, videos and so on. The memory 604 can be implemented by any type of volatile or non-volatile storages or the combination thereof, for example, Static Random Access Memories (SRAMs), Electrically Erasable Programmable Read-Only Memories (EEPROMs), Erasable Programmable Read-Only Memories (EPROMs), Programmable Read-Only Memories (PROMs), Read-Only Memories (ROMs), magnetic memories, flash memories, magnetic disks or optical disks.

The power supply component 606 supplies power for various components of the apparatus 600. The power supply component 606 can comprise a power supply management system, one or more power supplies, and other components associated with power generation, management and assignment for the apparatus 600.

The multimedia component 608 comprises a screen for providing an output interface between the apparatus 600 and the user. In some embodiments, the screen can comprise a liquid crystal display (LCD) and a touch panel (TP). If the screen comprises the touch panel, the screen can be implemented as a touch sensitive screen to receive input signals from the user. The touch panel comprises one or more touch sensors for sensing touch, slide, and gestures on the touch panel. The touch sensors can not only sense boundaries of a touch or slide action, but also detect duration and pressure related to a touch or slide operation. In some embodiments, the multimedia component 608 comprises a front camera and/or a rear camera. When the apparatus 600 is in operation (for example, in a camera mode or a video mode), the front camera and/or the rear camera can receive multimedia data from external. Each of the front camera and the rear camera can be a fixed optical lens system or have focus and optical zoom capability.

The audio component 610 is configured to output and/or input audio signals. For example, the audio component 610 comprises a microphone. When the apparatus 600 is in operation (for example, in a call mode, a recording mode, or a voice identification mode), the microphone is configured to receive audio signals from external. The received audio signals can be further stored in the memory 604 or transmitted via the communication component 616. In some embodiments, the audio component 610 further comprises a speaker for outputting the audio signals.

The I/O interface 612 provides an interface between the processor component 602 and peripheral interface modules such as a keyboard, a click wheel, buttons and so on. The buttons can comprise but are not limited to homepage buttons, volume buttons, start buttons and lock buttons.

The sensor component 614 comprises one or more sensors for providing various aspects of state elevations for the apparatus 600. For example, the sensor component 614 can detect On/Off state of the apparatus 600, and relative positions of the components (for example, a display and a keypad of the apparatus 600). The sensor component 614 can further detect the change of position of the apparatus 600 or a component of the apparatus 600, the presence of the touching by the user on the apparatus 600, location or acceleration/deceleration of the apparatus 600, and temperature change of the apparatus 600. The sensor component 614 can comprise a proximity sensor configured to detect the presence of a neighboring object without any physical touch. The sensor component 614 can further comprise an optical sensor such as a CMOS or CCD image sensor applicable for imaging. In some embodiments, the sensor component 614 can further comprise an acceleration sensor, a gyroscope sensor, a magnetic sensor, a pressure sensor or a temperature sensor.

The communication component 616 is configured to facilitate wireless or wire communication between the apparatus 600 and other devices. The apparatus 600 can access wireless networks based on communication standards such as 2G, 3G, or the combination thereof. In an exemplary embodiment, the communication component 616 receives broadcast signals or broadcast related information from an external broadcast management system via a broadcast channel. In an exemplary embodiment, the communication component 616 further comprises a near field communication (NFC) module for facilitating short range communication. For example, the NFC module can be implemented based on a Radio Frequency Identification (RFID) technology, an Infrared Data Association (IrDA) technology, an Ultra Wideband (UWB) technology, a Blue Tooth (BT) technology and other technologies.

In an exemplary embodiment, the apparatus 600 can be implemented by one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), controllers, microcontrollers, microprocessors, or other electronic elements so as to implement the above methods for presenting multimedia information.

In an exemplary embodiment, there is provided a non-transitory computer readable storage medium including instructions, such as included in the memory 604, executable by the processor 620 of the apparatus 600 to implement the above methods for presenting multimedia information. For example, the non-temporary computer readable storage medium can be a ROM, a Random Access Memory (RAM), a CD-ROM, a magnetic tape, a floppy disk, an optical data storage device and so on.

One of ordinary skill in the art will understand that the above described modules can each be implemented by hardware, or software, or a combination of hardware and software. One of ordinary skill in the art will also understand that multiple ones of the above described modules may be combined as one module, and each of the above described modules may be further divided into a plurality of submodules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for presenting multimedia information, comprising:
upon detecting a start event of an application, determining multimedia information to be presented in the application in accordance with predetermined presenting policies and a set of multimedia information, wherein the set of multimedia information includes at least one piece of multimedia information; and
presenting the determined multimedia information in a start interface of the application.

2. The method of claim 1, further comprising:
downloading the predetermined presenting policies and the set of multimedia information via an interface with a server.

3. The method of claim 1, wherein the determining multimedia information to be presented in the application in accordance with the predetermined presenting policies and the set of multimedia information comprises:
when the predetermined presenting policies include a list of presenting applications, determining whether the application is included in the list of presenting applications; and
when the application is included in the list of presenting applications, determining the multimedia information to be presented in the application in accordance with the predetermined presenting policies and the set of multimedia information.

4. The method of claim 1, wherein the determining multimedia information to be presented in the application in accordance with the predetermined presenting policies and the set of multimedia information comprises:
when the predetermined presenting policies include a presenting time period of the application, acquiring a system time indicated by a system clock;
determining whether the system time is within the presenting time period; and
when the system time is within the presenting time period, determining the multimedia information to be presented in the application in accordance with the predetermined presenting policies and the set of multimedia information.

5. The method of claim 1, wherein the determining multimedia information to be presented in the application in accordance with the predetermined presenting policies and the set of multimedia information comprises:
when the predetermined presenting policies include a first presenting frequency, calculating a total presenting frequency on the basis of presenting frequencies of applications installed on a terminal, wherein the first presenting frequency is a maximum presenting frequency of the terminal; and
when the total presenting frequency is less than the first presenting frequency, determining the multimedia information to be presented in the application in accordance with the predetermined presenting policies and the set of multimedia information.

6. The method of claim 1, wherein the determining multimedia information to be presented in the application in accordance with the predetermined presenting policies and the set of multimedia information comprises:
when the predetermined presenting policies include designated multimedia information corresponding to the application, acquiring the designated multimedia information from the set of multimedia information.

7. The method of claim 6, further comprising:
when the predetermined presenting policies include a plurality of pieces of designated multimedia information corresponding to the application and second presenting frequencies of the pieces of designated multimedia information, for a first one of the pieces of designated multimedia information corresponding to the application, acquiring a presenting frequency of the first one of the pieces of designated multimedia information, wherein each of the second presenting frequencies is a maximum presenting frequency of a corresponding piece of designated multimedia information; and
when the presenting frequency of the first one of the pieces of designated multimedia information is less than a corresponding second presenting frequency, selecting the first one of the pieces of designated multimedia information to be the multimedia information to be presented in the application.

8. The method of claim 1, wherein the determining multimedia information to be presented in the application in accordance with the predetermined presenting policies and the set of multimedia information comprises:
acquiring a weight of each piece of multimedia information in the set of multimedia information, wherein the weight indicates a probability of a corresponding piece of multimedia information being selected for presentation; and
selecting the multimedia information to be presented in the application from the set of multimedia information according to the weight of each piece of multimedia information.

9. The method of claim 1, further comprising:
upon detecting a viewing operation with respect to the presented multimedia information, displaying a page showing detailed information of the presented multimedia information; or
upon detecting a sharing operation with respect to the presented multimedia information, transmitting a sharing request for the presented multimedia information to the server; or
after the presenting of the multimedia information is finished, displaying a main interface of the application.

10. An apparatus for presenting multimedia information, comprising:
a processor; and
a memory configured to store instructions executable by the processor,
wherein the processor is configured to:
upon detecting a start event of an application, determine multimedia information to be presented in the application in accordance with predetermined presenting policies and a set of multimedia information, wherein the set of multimedia information includes at least one piece of multimedia information; and
present the multimedia information in a start interface of the application.

11. The apparatus of claim 10, wherein the processor is further configured to:
download the predetermined presenting policies and the set of multimedia information via an interface with a server.

12. The apparatus of claim 10, wherein the processor is further configured to:
when the predetermined presenting policies include a list of presenting applications, determine whether the application is included in the list of presenting applications; and
when the application is included in the list of presenting applications, determine the multimedia information to be presented in the application in accordance with the predetermined presenting policies and the set of multimedia information.

13. The apparatus of claim 10, wherein the processor is further configured to:
when the predetermined presenting policies include a presenting time period of the application, acquire a system time indicated by a system clock;
determine whether the system time is within the presenting time period; and
when the system time is within the presenting time period, determine the multimedia information to be presented in the application in accordance with the predetermined presenting policies and the set of multimedia information.

14. The apparatus of claim 10, wherein the processor is further configured to:
when the predetermined presenting policies include a first presenting frequency, calculate a total presenting frequency on the basis of presenting frequencies of applications installed on a terminal, wherein the first presenting frequency is a maximum presenting frequency of the terminal; and
when the total presenting frequency is less than the first presenting frequency, determine the multimedia information to be presented in the application in accordance with the predetermined presenting policies and the set of multimedia information.

15. The apparatus of claim 10, wherein the processor is further configured to:
when the predetermined presenting policies include designated multimedia information corresponding to the application, acquire the designated multimedia information from the set of multimedia information.

16. The apparatus of claim 15, wherein the processor is further configured to:
when the predetermined presenting policies include a plurality of pieces of designated multimedia information corresponding to the application and second presenting frequencies of the pieces of designated multimedia information, for a first one of the pieces of designated multimedia information corresponding to the application, acquire a presenting frequency of the first one of the pieces of designated multimedia information, wherein each of the second presenting frequencies is a maximum presenting frequency of a corresponding piece of designated multimedia information; and
when the presenting frequency of the first one of the pieces of designated multimedia information is less than a corresponding second presenting frequency, select the first one of the pieces of designated multimedia information to be the multimedia information to be presented in the application.

17. The apparatus of claim 10, wherein the processor is further configured to:
acquire a weight of each piece of multimedia information in the set of multimedia information, wherein the weight indicates a probability of a corresponding piece of multimedia information being selected for presentation; and
select the multimedia information to be presented in the application from the set of multimedia information according to the weight of each piece of multimedia information.

18. The apparatus of claim 10, wherein the processor is further configured to:
transmit a sharing request for the multimedia information to a server upon detecting a sharing operation with respect to the presented multimedia information.

19. The apparatus of claim 10, wherein the processor is further configured to:
upon detecting a viewing operation with respect to the presented multimedia information, display a page showing detailed information of the presented multimedia information; and
after the presenting of the multimedia information is finished, display a main interface of the application.

20. A non-transitory computer-readable storage medium storing instructions that, when executed by a processor of an apparatus, cause the apparatus to perform a method for presenting multimedia information, the method comprising:
upon detecting a start event of an application, determining multimedia information to be presented in the application in accordance with predetermined presenting policies and a set of multimedia information, wherein the set of multimedia information includes at least one piece of multimedia information; and
presenting the multimedia information in a start interface of the application.
